(19) United States
(12) Patent Application Publication
(10) Pub. No.: US 2008/0201549 A1
(43) Pub. Date: Aug. 21, 2008

(54) System and Method for Improving Data Caching

(75) Inventors: Shannon V. Davidson, Hillsboro, MO (US); James D. Ballew, Grapevine, TX (US)

Correspondence Address: BAKER BOTTS LLP, 2001 ROSS AVENUE, 6TH FLOOR, DALLAS, TX, 75201-2980, US

(73) Assignee: Raytheon Company, Waltham, MA (US)

(21) Appl. No.: 11/676,874

(22) Filed: Feb. 20, 2007

(51) Int. Cl. G06F 12/00

(52) U.S. Cl. 711/173; 711/E12.002

(57) ABSTRACT

According to one embodiment of the present invention, a method for storing data includes partitioning the data into a plurality of sections and storing the sections on one or more server nodes of a plurality of server nodes. The method further includes caching one or more sections of the plurality of sections of data onto one or more caches nodes of a plurality of cache nodes. The method further includes storing, for each section of data, the identity of the particular cache node on which the section of data is cached.

### TECHNICAL FIELD OF THE INVENTION

This invention relates generally to the field of caching and more specifically to a system and method for improving data caching.

### BACKGROUND OF THE INVENTION

High performance computing applications typically require access to large sets of data which are stored in disk-based files or databases. To prevent the reduction of efficiency of the computing system, the most recently used data is stored in the local memory of a computer as a cache buffer.

Standard processes for maximizing the amount of data that may be cached involve caching data on client computers, server computers, or both. These processes, however, have disadvantages. For example, if data is only cached on either client computers or server computers, the amount of data that may be cached is limited because the amount of memory that may be used to cache data is typically less than 1% of the secondary storage capacity for a computer. Furthermore, if two client computers are using the same data and one client computer changes the data, the data is not normally updated for the second client computer. Additionally, when a client computer needs to access data it does not have cached in its own local memory, the client computer must communicate with all of the server computers and all of the client computers to find where the data is cached. This reduces the effectiveness of the caching process.

### SUMMARY OF THE INVENTION

In accordance with the present invention, disadvantages and problems associated with previous techniques for caching data may be reduced or eliminated.

According to one embodiment of the present invention, a method for storing data includes partitioning the data into a plurality of sections and storing the sections on one or more server nodes of a plurality of server nodes. The method further includes caching one or more sections of the plurality of sections of data onto one or more caches nodes of a plurality of cache nodes. The method further includes storing, for each section of data, the identity of the particular cache node on which the section of data is cached.

Certain embodiments of the invention may provide one or more technical advantages. A technical advantage of one embodiment may be that because data is cached in both a cache system and a server system, both of which may contain any amount of computers, there is essentially no limit to the amount of data that may be cached. A further technical advantage of one embodiment of the invention may be that as a result of a cache system operating in between one or more client nodes and one or more server nodes, the cache system caches any data used by the client nodes and accesses any data cached in the server nodes. Therefore, any data changed by a client node is changed at the cache system, allowing all client nodes access to the changed data. Additionally, the cache nodes only have to communicate with the cache system in order to access any data needed.

Certain embodiments of the invention may include none, some, or all of the above technical advantages. One or more technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1A is a diagram of one embodiment of a system capable of accessing and storing data;

FIG. 1B is a block diagram illustrating one embodiment a client node of the system of FIG. 1A;

FIG. 1C is a block diagram illustrating one embodiment of a cache node of the system of FIG. 1A;

FIG. 1D is a block diagram illustrating one embodiment of a server node of the system of FIG. 1A;

FIG. 1E is a flow chart showing the operation of the system of FIG. 1A and illustrating one embodiment of a method for accessing cached or stored data;

FIG. 2A is one embodiment of a system capable of handling the failure of one or more cache nodes; and

FIG. 2B is a flow chart illustrating one embodiment of a method for handling cache node failures.

### DETAILED DESCRIPTION OF EXAMPLE EMBODIMENTS OF THE INVENTION

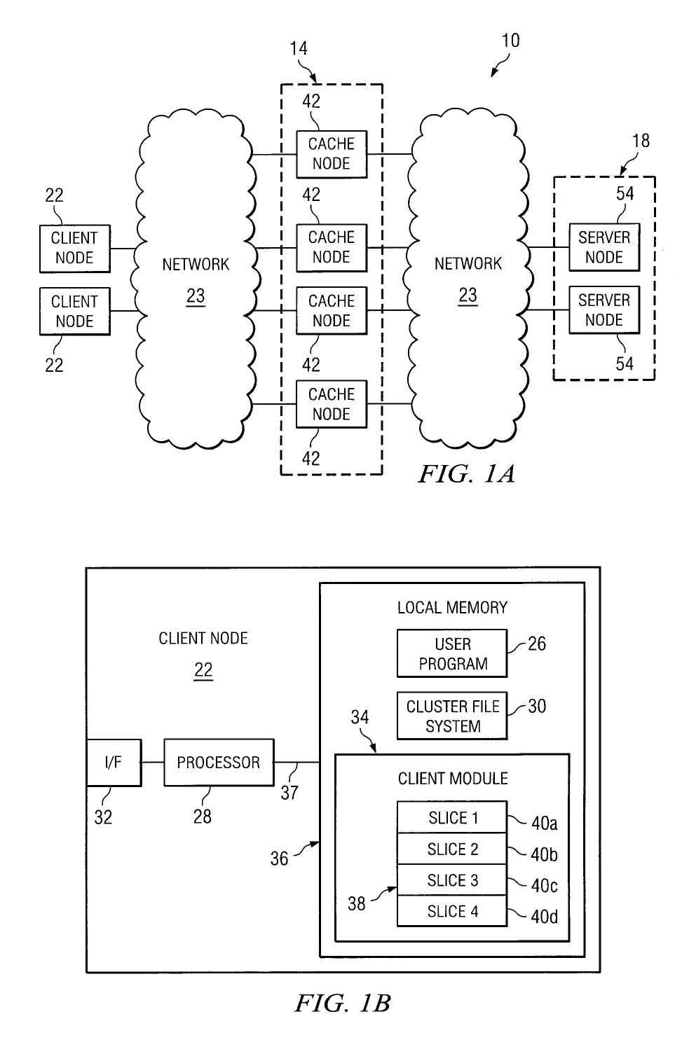

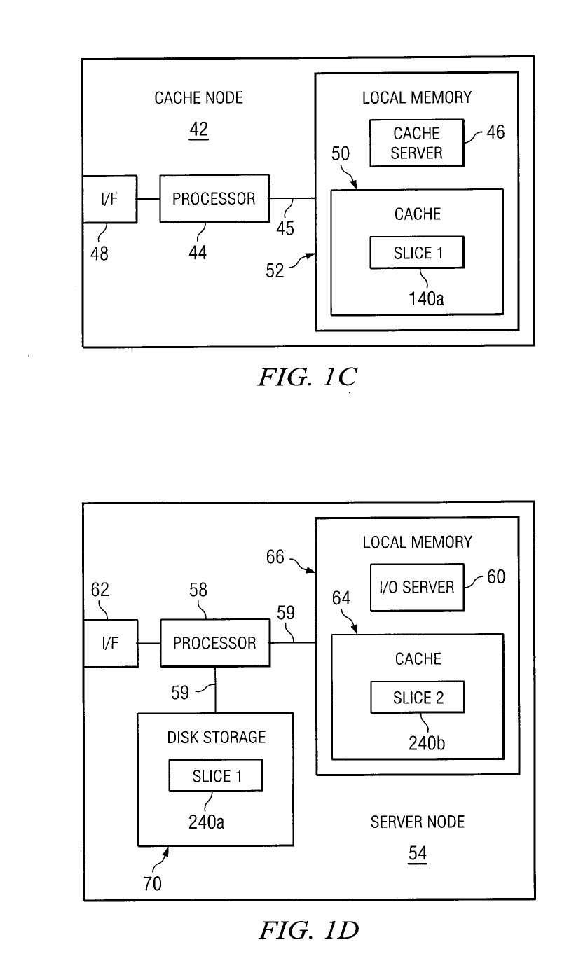

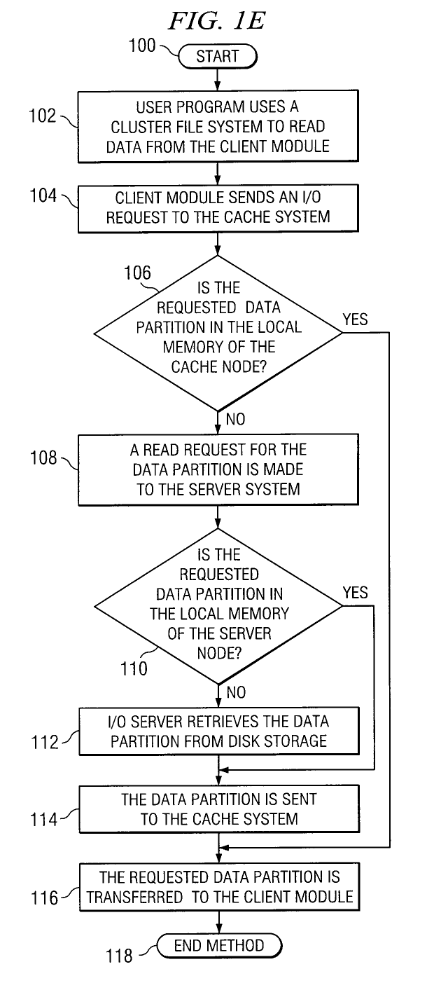

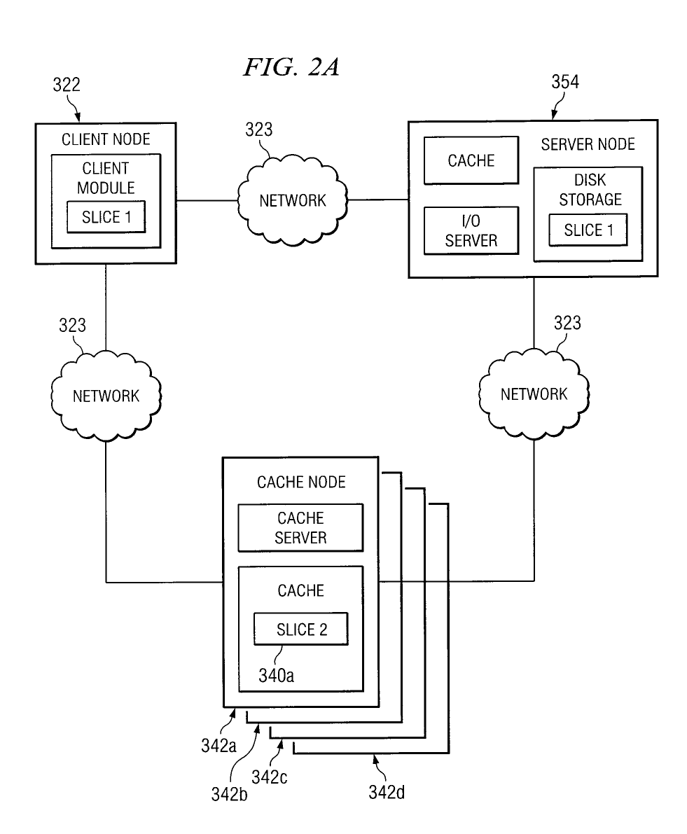

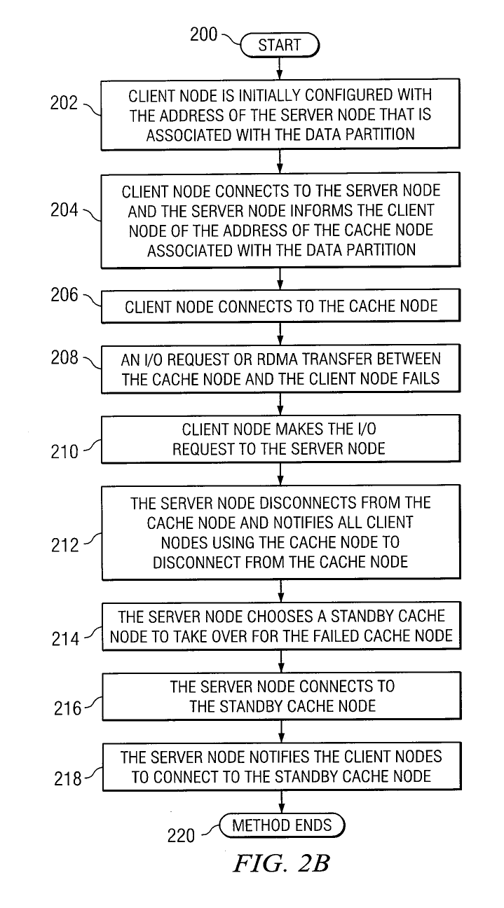

Embodiments of the present invention and its advantages are best understood by referring to FIGS. 1A through 2B of the drawings, like numerals being used for like and corresponding parts of the various drawings.

FIG. 1A is a diagram of one embodiment of a system 10 capable of accessing and storing data. Generally, system 10 includes a cache system 14 and a server system 18. Cache system 14 allows data to be cached and further allows one or more client nodes 22, to access the cached data using a network. By caching data in cache system 14, client nodes 22 may access the same data simultaneously and any data changed by one client node 22 may be accessed by all client nodes 22. Server system 18 allows data to be cached and further allows data to be stored in disk storage. This allows for additional data to be cached and the remaining data to be stored in disk storage, enabling client nodes 22 access, through a network, to both the cached data and the data stored in disk storage. Together, the two layers of caching provided by cache system 14 and server system 18 increase the amount of data that may be cached, decreasing the amount of time needed by client nodes 22 to access the data. In the illustrated embodiment, system 10 includes client nodes 22, cache system 14, server system 18, and a network 23.

Client node 22 is capable of running one or more applications and further capable of accessing data stored on both cache system 14 and server system 18 using network 23. In one embodiment, client node 22 may include a personal digital assistant, a computer, such as a laptop, a cellular telephone, a mobile handset, or any other device capable of running one or more applications and further capable of accessing data stored on both cache system 14 and server system 18 through network 23. In the illustrated embodiment, client node 22 refers to a computer. Client node 22 is discussed further in reference to FIG. 1B.

Cache system 14 is capable of caching data and further capable of allowing client nodes 22 to access the cached data. In the illustrated embodiment, cache system 14 includes one or more cache nodes 42. Cache node 42 is capable of caching data, receiving data requests from client nodes 22, transmitting data requests to server system 18, and transmitting data to client nodes 22 and server system 18. In one embodiment, cache node 42 may include a personal digital assistant, a computer, a laptop computer, a cellular telephone, a mobile handset, or any other device capable of caching data, receiving data requests from client nodes 22, transmitting data requests to server system 38, and transmitting data to client nodes 22 and server system 18. In the illustrated embodiment, cache node 42 refers to a computer. Cache node 42 is discussed further in reference to FIG. 1C.

Server system 18 is capable of caching data and storing additional data in disk storage. In the illustrated embodiment, server system 18 includes one or more server nodes 54. Server node 54 is capable of receiving data requests from cache server 14, receiving data from cache system 14, caching data, storing data, and transmitting data to cache system 14. In one embodiment, server node 54 may include a personal digital assistant, a computer, such as a server, a cellular telephone, a mobile handset, or any other device capable of receiving data requests from cache system 14, receiving data from cache system 14, caching data, storing data, and transmitting data to cache system 14. In the illustrated embodiment, server node 54 refers to a server. Server node 54 is discussed further in reference to FIG. 1D.

Network 23 connects client nodes 22, cache system 14, and server system 18 to each other, allowing for the sharing of data. Network 23 may refer to any interconnecting system capable of transmitting audio, video, signals, data, messages, or any combination of the preceding. Network 23 may comprise all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, or any combination of the preceding.

High performance computing applications typically require access to large sets of data which are stored in disk-based files or databases. To prevent the reduction of efficiency of the computing system, the most recently used data is stored in the local memory of a computer as a cache buffer. The cache buffer improves both the data access time and the overall performance of the application. Unfortunately, the local memory of a computer is limited to typically less than 1% of the secondary storage capacity for a computer. Therefore, very little data can be cached.

Traditionally, attempts to maximize the amount of data that can be cached have centered on caching data in client computers, server computers, or both. Caching data in client computers or server computers restricts the amount of data that may be cached, as discussed above. Using both client computers and server computers increases the amount of data that may be cached, but also presents various problems. For example, if two client computers are using the same data and one client computer changes the data, the data is not normally updated for the second client computer. This reduces the effectiveness of the caching process.

Additionally, other problems exist when a client computer needs to access data it does not have cached in its own local memory. When this is the case, conventionally, the client computer must communicate with all of the server computers and all of the client computers, searching for which computer is caching the needed data. This also reduces the effectiveness of the caching process since it slows down the process and also causes a client computer to sometimes not find the data needed.

Some embodiments of the present invention allow for a large amount of data to be cached without incurring the problems associated with the traditional processes. In the illustrated embodiment of the invention, data is cached in both cache system 14 and server system 18. Because each system may contain any amount of computers, there is essentially no limit to the amount of data that may be cached. Additionally, cache system 14 operates in between client nodes 22 and server nodes 54, caching any data used by client nodes 22 and accessing any data cached in server nodes 54. In doing so, any data changed by one client node 22 is changed at cache system 14, allowing all client nodes 22 access to the changed data. Moreover, client nodes 22 do not have to communicate with each other in order to access data. Instead, client nodes 22 simply communicate with cache system 14, increasing the effectiveness of the caching process.

FIG. 1B is a block diagram illustrating one embodiment of client node 22. In the illustrated embodiment, client node 22 includes a processor 28, a communication interface 32, and a local memory 36 communicatively coupled to processor 38 by a bus 37. Stored in local memory 36 is a user program 26, a cluster file system 30, a client module 34, and data 38.

Processor 28 may refer to any suitable device capable of executing instructions and manipulating data to perform operations for cache node 22. For example, processor 28 may include any type of central processing unit (CPU). Communication interface 32 may refer to any suitable device capable of receiving input for client node 22, sending output from client node 22, performing suitable processing of the input or output or both, communicating to other devices, or any combination of the preceding. For example, communication interface 32 may include appropriate hardware (e.g., modem, network interface card, etc.) and software, including protocol conversion and data processing capabilities, to communicate through a LAN, WAN, or other communication system that allows client node 22 to communicate to other devices. Communication interface 32 may include one or more ports, conversion software, or both. Local Memory 36 may refer to any suitable device capable of caching data and facilitating retrieval of the cached data. For example, local memory 36 may include random access memory (RAM). Bus 37 facilitates communication between processor 28 and local memory 38. Bus 37 may refer to any suitable device or connection capable of communicatively coupling processor 28 to local memory 38.

User program 26 provides an interface between a user and client node 22. In one embodiment, user program 26 includes any computer software capable of conducting a task that a user wishes to perform. Cluster file system 30 is capable of accessing client module 34 in order to retrieve partitions of data 38 for storage. In the illustrated embodiment, cluster file system 30 retrieves and stores partitions of data 38 for user program 26.

Client module 34 is capable of transmitting requests for partitions of data 38 and is further capable of accessing partitions of data 38 from cache system 14. In one embodiment, client module 34 may include a software component in client node 22.

Data 38 is used by user program 26 running on client node 22. Data 38 may refer to any data required by user program 26. For example, data 38 may include file system metadata or data blocks. In one embodiment, data 38 includes data blocks partitioned into one or more partitions, however, data 38 may be stored in any suitable manner. In the illustrated example embodiment, data 38 is partitioned into four partitions: data partitions 40a-d. In one embodiment, the partitioning of data 38 into data partitions 40 may be accomplished by hard partitioning (e.g. the Linux fdisk or parted program) or soft partitioning (e.g. specifying in a configuration file the region of data storage where each slice of data may be found).

In the illustrated embodiment, user program 26 accesses cluster file system 30, which in turn accesses client module 34. Client module 34 accesses data partitions 40 from cache system 14 using network 23. In the illustrated embodiment, accessing data partitions 40 includes reading data partitions 40 and further includes writing to data partitions 40.

FIG. 1C is a block diagram illustrating one embodiment of cache node 42. In the illustrated embodiment, cache node 42 includes a processor 44, a communication interface 48, a local memory 52, and a bus 45 communicatively coupling processor 44 to local memory 52. Stored in local memory 52, in one embodiment, is a user program 26, a cache server 34, a cache 50, and one or more data partitions 140.

Processor 44 may refer to any suitable device capable of executing instructions and manipulating data to perform operations for cache node 42. For example, processor 44 may include any type of central processing unit (CPU). Communication interface 48 may refer to any suitable device capable of receiving input for cache node 42, sending output from cache node 42, performing suitable processing of the input or output or both, communicating to other devices, or any combination of the preceding. For example, communication interface 48 may include appropriate hardware (e.g., modem, network interface card, etc.) and software, including protocol conversion and data processing capabilities, to communicate through a LAN, WAN, or other communication system that allows cache node 42 to communicate to other devices. Communication interface 48 may include one or more ports, conversion software, or both. Local Memory 52 may refer to any suitable device capable of caching and facilitating retrieval of the cached data. For example, local memory 52 may include random access memory (RAM). Bus 45 facilitates communication between processor 44 and local memory 52. Bus 45 may refer to any suitable device or connection capable of communicatively coupling processor 44 to local memory 52.

Cache server 46 is capable of handling requests for data partitions 140 from client nodes 22, caching data partitions 140, transferring data partitions 140 to each client module 34, and transferring data partitions 140 to server system 18. In one embodiment, cache server 46 may include a software component in cache node 42.

Cache 50 refers to the area of local memory 52 where data partitions 140 are cached. Data partitions 140 are substantially similar to data partitions 40 of data 38 of FIG. 1B. In the illustrated embodiment, data partitions 140 cached in cache 50 include only data partition 140a. In further embodiments, data partitions 140 cached in cache 50 may include more data partitions 140 or different data partitions 140. For example, data partitions 140 cached in cache 50 may include data partition 140b and data partition 140d.

FIG. 1D is a block diagram illustrating one embodiment of server node 54. In the illustrated embodiment, server node 54 includes a processor 58, a communication interface 62, a local memory 66, a disk storage 70, and a bus 59 communicatively coupling processor 58 to local memory 66 and disk storage 70. Stored in local memory 66, in one embodiment, is a I/O server 60, a cache 64, and one or more data partitions 240. Stored in disk storage 70, in one embodiment, are data partitions 240.

Processor 58 may refer to any suitable device capable of executing instructions and manipulating data to perform operations for server node 54. For example, processor 58 may include any type of central processing unit (CPU). Communication interface 62 may refer to any suitable device capable of receiving input for server node 54, sending output from server node 54, performing suitable processing of the input or output or both, communicating to other devices, or any combination of the preceding. For example, communication interface 62 may include appropriate hardware (e.g., modem, network interface card, etc.) and software, including protocol conversion and data processing capabilities, to communicate through a LAN, WAN, or other communication system that allows server node 54 to communicate to other devices. Communication interface 62 may include one or more ports, conversion software, or both. Local Memory 66 may refer to any suitable device capable of caching and facilitating retrieval of the cached data. For example, memory device 66 may include random access memory (RAM). Bus 59 facilitates communication between processor 58, local memory 66, and disk storage 70. Bus 59 may refer to any suitable device or connection capable of communicatively coupling processor 58 to local memory 66 and disk storage 70.

I/O server 60 is capable of receiving requests for data partitions 240 from cache server 14, caching data partitions 240, storing data partitions 240 in disk storage 70, retrieving data partitions 240 from disk storage 70, and transmitting data partitions 240 to cache system 14. In one embodiment, I/O server 60 may include a software component in server node 54.

Cache 64 refers to the area of local memory 66 where data partitions 240 are cached. Data partitions 240 are substantially similar to data partitions 40 of data 38 of FIG. 1B. In the illustrated embodiment, data partitions 240 cached in cache 64 include only data partition 240b. In further embodiments, data partitions 240 cached in cache 64 may include more data partitions 240 or different data partitions 240. For example, data partitions 240 cached in cache 64 may include data partition 240a and data partition 240d.

Disk storage 70 is capable of storing data partitions 240 and is further capable of being accessed by I/O server 60. Disk storage 70 refers to memory storage. For example, disk storage 70 may include a magnetic disk, an optical disk, flash memory, or other suitable data storage device. In the illustrated embodiment, disk storage 70 includes a magnetic drive. In the illustrated embodiment, data partitions 240 stored in disk storage 70 include only data partition 240a. In further embodiments, data partitions 240 stored in disk storage 70 may include more data partitions 240 or different data partitions 240. For example, data partitions 240 stored in disk storage 70 may include data partition 240b and data partition 240d. In a further embodiment, when I/O server 60 accesses data partitions 240 stored in disk storage 70, I/O server caches the same data partitions 240 in cache 64.

FIG. 1E is a flow chart showing the operation of system 10 and illustrating one embodiment of a method for accessing cached or stored data. The method begins at step 100. At step 102, user program 26 uses cluster file system 30 to read data 38 from client module 34. In one embodiment, data 38 may include one or more data partitions, causing the method to be repeated for each data partition of data 38. To satisfy the read request for data 38, at step 104, client module 34 sends a request for a partition of data 38, such as data partition 40a, to cache system 14. In one embodiment, each partition of data 38 is associated with only one particular cache node 42 of cache system 14. For example, if data partition 40a is associated with one particular cache node 42, data partition 40a may only be cached at that particular cache node 42. This allows client module 34 to send the request for data partition 40a to only the appropriate cache node 42 of cache system 14. In a further embodiment, each partition of data 38 may be associated with more than one cache node 42.

At step 106, cache server 14 checks local memory 52 of cache node 42 to see if data partition 40a is cached in cache node 42. If data partition 40a is cached in cache node 42, the method continues on to step 116 where data partition 40a is transferred back to client module 34 from cache node 42. At step 118, the method ends.

Referring back to step 106, if data partition 40a is not cached in cache node 42, the process moves to step 108 where cache node 42 sends a request for data partition 40a to server system 18. In one embodiment, each partition of data 38, such as data partition 40a, is associated with only one particular server node 54 of server system 18. Therefore, if cache node 42 does not have data partition 40a cached in local memory 52, data partition 40a can only be cached or stored at the one particular server node 54 associated with data partition 40a. In a further embodiment, each partition of data 38 may be associated with more than one server node 54.

At step 110, I/O server 60 of the server node 54 associated with data partition 40a checks to see if data partition 40a is cached in local memory 66. If data partition 40a is not cached in local memory 66, the method continues on to step 112 where I/O server 60 retrieves data partition 40a from disk storage 70 located in server node 54. In one embodiment, by retrieving data partition 40a, I/O server 60 also caches data partition 40a in local memory 66. At step 114, data partition 40a is sent to cache system 14. In one embodiment, data partition 40a is only sent to the one particular cache node 42 associated with data partition 40a. At step 116, data partition 40a is transferred to client module 34, allowing user program 26 to read data partition 40a of data 38 The method ends at step 118.

Referring back to step 110, if data partition 40a is cached in local memory 66 of server node 54, the method moves to step 114 where data partition 40a is sent to, in one embodiment, cache system 14. At step 116, data partition 40a is transferred to client module 34, allowing user program 26 to read data partition 40a of data 38. At step 118, the method ends.

In the illustrated example embodiment of the operation of system 10, partitions of data 38, such as data partition 40a, are cached in both cache system 14 and server system 18. Because cache system 14 may essentially have a limitless amount of cache nodes 42 and server system 18 may essentially have a limitless amount of server nodes 54, there is essentially no limit to the amount of partitions of data 38 that may be cached. Additionally, cache system 14 operates in between client nodes 22 and server nodes 54. In doing so, any partitions of data 38 changed by one client node 22 are changed at cache system 14, allowing all client nodes 22 access to the changed partitions of data 38. Moreover, client nodes 22 do not have to communicate with each other in order to access partitions of data 38. Instead, client nodes 22 simply communicate with cache system 14, increasing the effectiveness of the caching process.

FIG. 2A is a further embodiment of system 10 in which system 10 is capable of handling the failure of one or more cache nodes 342a-d. In the illustrated embodiment, system 10 includes one or more client nodes 322, cache nodes 342a-d, one or more server nodes 354, and network 323.

Client node 322 is capable of running one or more applications and further capable of accessing one or more data partitions 340 cached in cache nodes 342a-d and stored or cached in server node 354. Client node 322 is substantially similar to client node 22 of FIGS. 1A and 1B.

Cache nodes 342a-d are capable of caching data partitions 340, receiving requests for data partitions 340 from client nodes 322, transmitting requests for data partitions 340 to server nodes 354, and transmitting data partitions 340 to client nodes 322 and server nodes 354. Cache nodes 342a-d are substantially similar to client nodes 42 of FIGS. 1A and 1C. Data partitions 340 are substantially similar to data partitions 40 of data 38 of FIG. 1B.

In the illustrated embodiment, cache node 342a is associated with only data partition 340a. Therefore, in one embodiment, if cache node 342a were to fail, client node 322 would be unable to access data partition 340a. To solve this, cache nodes 342b-d may also be associated with data partition 340a. This allows client node 322 to access data partition 340a from cache nodes 342b-d despite the failure of cache node 342a. In one embodiment, cache nodes 342b-d may only cache data partition 340a and transmit data partition 340a to client nodes 322 if cache node 342a has failed. In one embodiment, cache node 342a may fail if the connection, through network 323, fails between cache node 342a and client node 322 or cache node 342a and server node 354.

Server node 354 is capable of receiving requests for data partitions 340 from cache nodes 342a-d, caching data partitions 340, storing data partitions 340, transmitting data partitions 340 to cache nodes 342a-d, and configuring cache nodes 342b-d so that they may cache data partitions 340 if cache node 342a fails. Server node 354 is substantially similar to server node 54 of FIGS. 1A and 1D.

Network 323 connects client nodes 322, cache nodes 342, and server nodes 354 to each other, allowing for the sharing of data partitions 340. Network 323 is substantially similar to network 23 of FIG. 1A.

FIG. 2B is a flow chart illustrating one embodiment of a method of system 10 for handling cache node 342 a-d failures. The method begins at step 200. At step 202, client node 322 is configured with the address of the one server node 354 associated with data partition 340a needed by client node 322. At step 204, client node 322 connects, using network 323, to server node 354. Server node 354 informs client node 322 of the address of the cache node 342a associated with data partition 340a.

Using the obtained address, at step 206, client node 322 connects, using network 323, to cache node 342a. At step 208, a request for data partition 340a or a transfer of data partition 340a between client node 322 and cache node 342a fails. As a result, at step 210, client node 322 makes a request for data partition 340a directly to the server node 354 associated with data partition 340a.

The request made by client node 322 informs server node 354 that the connection between client node 322 and cache node 342a has failed. At step 212, server node 354 disconnects from failed cache node 342a and notifies any other client nodes 322 using cache node 342a to disconnect from cache node 342a. At step 214, server node 354 chooses a standby cache node 342b associated with data partition 340a to take over for the failed cache node 342a. In one embodiment, server node 322 may choose standby cache node 342c, standby cache node 342d, or any other suitable cache node 342. At step 216, server node 342 connects to cache node 342b. At step 218, server node 354 notifies all client nodes 322 previously using failed cache node 342a to connect to standby cache node 342b. Once client node 322 is connected to standby cache node 342b, the problem resulting from the failure of cache node 342a is solved. At step 220, the method ends.

Although this disclosure has been described in turns of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure, as defined by the following claims.

What is claimed is:

1. A method for storing data, comprising:
partitioning the data into a plurality of sections and storing the sections on one or more server nodes of a plurality of server nodes; and
caching one or more sections of the plurality of sections of data onto one or more caches nodes of a plurality of cache nodes and storing, for each section of data, the identity of the particular cache node on which the section of data is cached.

2. The method of claim 1, further comprising accessing the one or more sections of the plurality of sections of data cached on the one or more cache nodes of the plurality of caches nodes using one or more client nodes.

3. The method of claim 2, wherein accessing the one or more sections of the plurality of sections of data cached on the one or more cache nodes of the plurality of caches nodes using one or more client nodes comprises permitting the one or more client nodes to read the one or more sections of the plurality of sections of data.

4 The method of claim 2, wherein accessing the one or more sections of the plurality of sections of data cached on the one or more cache nodes of the plurality of caches nodes using one or more client nodes comprises:
permitting the one or more client nodes to write to the one or more sections of the plurality of sections of data; and
allowing the one or more client nodes to access the one or more sections of the plurality of sections of data after they have been written to by the one or more client nodes.

5. The method of claim 1, wherein caching one or more sections of the plurality of sections of data onto one or more caches nodes of a plurality of cache nodes comprises accessing the one or more sections of the plurality of sections of data stored on the one or more server nodes using the one or more cache nodes.

6. The method of claim 1, wherein storing the sections on one or more server nodes of a plurality of server nodes comprises caching the sections on the one or more server nodes.

7. The method of claim 1, further comprising storing, for each section of data of the plurality of sections of data, the identity of the particular server node of the plurality of server nodes on which the section of data is cached.

8. The method of claim 1, wherein at least one of the cache nodes of the one or more cache nodes is stored on one of the server nodes of the plurality of server nodes.

9. The method of claim 2, wherein accessing the one or more sections of the plurality of sections of data cached on the one or more cache nodes of the plurality of caches nodes using one or more client nodes comprises accessing the one or more sections of the plurality of sections of data cached on one or more standby cache nodes using the one or more client nodes.

10. A system for storing data, comprising:
data partitioned into a plurality of sections;
a plurality of server nodes operable to store one or more sections of the plurality of sections of data; and
a plurality of cache nodes operable to cache the one or more sections of the plurality of sections of data.

11. The system of claim 10, further comprising one or more client nodes operable to access the one or more sections of the plurality of sections of data cached on one or more cache nodes of the plurality of cache nodes.

12. The system of claim 11, wherein the one or more client nodes are further operable to read the one or more sections of the plurality of sections of data.

13. The system of claim 11, wherein the one or more client nodes are further operable to:
write to the one or more sections of the plurality of sections of data; and
access the one or more sections of the plurality of sections of data after they have been written to by the one or more client nodes.

14. The system of claim 10, wherein one or more cache nodes of the plurality of cache nodes are further operable to access the one or more sections of the plurality of sections of data stored on one or more server nodes of the plurality of server nodes.

15. The system of claim 10, wherein a plurality of server nodes operable to store one or more sections of the plurality of sections of data further comprises a plurality of server nodes operable to cache one or more of the sections of the plurality of sections of data.

16. The system of claim 10, wherein one or more cache nodes of the plurality of cache nodes are further operable to store the identity of the particular server node of the plurality of server nodes on which each section of the plurality of sections of data is stored.

17. The system of claim 11, wherein the one or more client nodes are further operable to store the identity of the particular cache node of the plurality of cache nodes on which each section of the plurality of sections of data is cached.

18. The system of claim 10, wherein at least one of the server nodes of the plurality of server nodes further comprises at least one of the cache nodes of the plurality of cache nodes.

19. The system of claim 11, wherein the one or more client nodes are further operable to access the one or more sections of the plurality of sections of data cached on one or more standby cache nodes, the one or more standby cache nodes operable to cache the one or more sections of the plurality of sections of data cached on at least one cache node of the plurality cache nodes when the at least one cache node fails.

20. A method for storing data, comprising:
partitioning the data into a plurality of sections and storing the sections on one or more server nodes of a plurality of server nodes, wherein storing the sections on one or more server nodes of a plurality of server nodes comprises caching the sections on the one or more server nodes;
caching one or more sections of the plurality of sections of data onto one or more caches nodes of a plurality of cache nodes and storing, for each section of data, the identity of the particular cache node on which the section of data is cached, wherein caching one or more sections of the plurality of sections of data onto one or more caches nodes of a plurality of cache nodes comprises accessing the one or more sections of the plurality of sections of data stored on the one or more server nodes using the one or more cache nodes, wherein at least one of the cache nodes of the one or more cache nodes is stored on one of the server nodes of the plurality of server nodes;
accessing the one or more sections of the plurality of sections of data cached on the one or more cache nodes of the plurality of caches nodes using one or more client nodes, wherein accessing the one or more sections of the plurality of sections of data cached on the one or more cache nodes of the plurality of caches nodes using one or more client nodes comprises:
permitting the one or more client nodes to read the one or more sections of the plurality of sections of data;
permitting the one or more client nodes to write to the one or more sections of the plurality of sections of data; and
allowing the one or more client nodes to access the one or more sections of the plurality of sections of data after they have been written to by the one or more client nodes; and
storing, for each section of data of the plurality of sections of data, the identity of the particular server node of the plurality of server nodes on which the section of data is cached.
